(19) United States
(12) Patent Application Publication
(10) Pub. No.: US 2011/0080377 A1
(43) Pub. Date: Apr. 7, 2011

(54) Virtual image feedback for input devices

(76) Inventor: Everett Simons, Arlington, VA (US)

(21) Appl. No.: 12/587,167

(22) Filed: Oct. 2, 2009

(51) Int. Cl. G06F 3/033

(52) U.S. Cl. 345/179

(57) ABSTRACT

A display screen above a signature tablet faces downwards, towards the signature tablet. A transparent plate is located at a height half way between the tablet and the screen. A user observing the tablet through the transparent plate also sees a reflection of the screen. The reflection of the screen, called a virtual image, appears to be in the same plane as the top surface of the tablet. As the user signs the tablet with a stylus, the virtual image of the resulting signature follows behind the stylus. The signature appears to be on the top surface of the tablet, coplanar with the stylus path, rather than within the tablet. This allows the system to better simulate a traditional pen-on-paper signature. Separating the components responsible for sensing the stylus tip location and displaying the signature also allows for the independent optimization of the sensing and display functions.

### BACKGROUND OF THE INVENTION

1. Field of the Invention

The invention relates to devices that detect and display a handwritten input.

2. Description of Related Art

An electronic signature tablet can be used to capture a signature or other handwritten input, e.g. when authorizing a credit card transaction. The top surface of the signature tablet is a clear plate. The user holds a stylus and writes across the clear plate. The signature tablet senses the position of the stylus tip on the plate, and displays an image underneath the plate showing the path that the stylus has traversed. The display showing the stylus path appearing below the plate thus has a vertical offset below the actual stylus tip by at least the thickness of the plate.

For clarity, the act of writing with a stylus on a tablet shall be referred to as “signing” and a display showing the path of the stylus tip across the tablet surface shall be referred to as a “signature”, regardless of the actual contents of the handwritten input.

### Drawbacks of Typical Signature Tablets

When viewed from any location other than directly perpendicular to the plane of the top surface, the vertical offset of the signature below the stylus tip causes the signature to have an apparent horizontal offset from the actual path of the stylus tip. This apparent horizontal offset is called parallax error. The size of the parallax error varies, depending upon the user's line of sight. A conventional tablet thus has both a fixed vertical offset and a variable parallax error. Writing requires hand-eye coordination; for many users, the vertical offset and parallax error of a conventional tablet causes the resulting signature to be distorted.

### BRIEF SUMMARY OF THE INVENTION

An object of the invention is to reduce the vertical offset and parallax error by making the signature appear to be in the same plane as the surface being signed by the stylus tip. One embodiment uses a sensing tablet, an image source above the tablet, and a transparent plate with a flat, partially reflective surface midway between the tablet and the image source. The plate creates a partial reflection of the image source; this reflection is called a “virtual image”. The plate bisects the plane of the tablet and the plane of the image source. A user observing the tablet through the plate also sees the virtual image of the image source, apparently in the same plane as the top surface of the tablet.

The scale of the virtual image is 1:1 with respect to the image source. The location of the virtual image is fixed: the apparent location of the virtual image does not move merely because the user's perspective changes. The virtual image thus remains aligned to the corresponding locations on the tablet, independent of the user's perspective. When the user signs the tablet with the stylus, the signature appears in the virtual image, preferably as a bright line on a dark background. The two functions of detecting the location of the stylus tip and displaying the signature are thus accomplished by two separate components, the sensing tablet and the image source. Because the plane of the virtual image of the signature can be positioned independent of the thickness of the sensing tablet surface, the signature can appear in the same plane as the top of the sensing tablet surface, exactly where the stylus tip contacts the tablet. This eliminates vertical offset and thus avoids parallax error, facilitating an electronic signature more representative of the user's normal signature.

The term “virtual image” is used in its optical sense, and is defined herein to be an image formed by the apparent but not actual convergence (focus) of light rays from an image source. For clarity, the term “virtual” will not used herein to mean “simulated by computer”.

### BRIEF DESCRIPTION OF THE DRAWINGS

FIG. 1 illustrates a user observing signature tablet 13 through transparent plate 11. As the user signs using stylus 12, display 15 creates a mirror image of the signature, and a partial reflection of display 15 in plate 11 creates a virtual image of the signature in the same plane as the top of sensing tablet 13.

FIG. 2 illustrates a user observing signature tablet 13 through transparent plate 21. As the user signs using stylus 12, display 25 creates a mirror image of the signature, and a partial reflection of display 25 in plate 21 creates a virtual image of the signature in the same plane as the top of sensing tablet 13. Because display 25 faces downwards, displayed information is not readily visible to bystanders.

### DETAILED DESCRIPTION

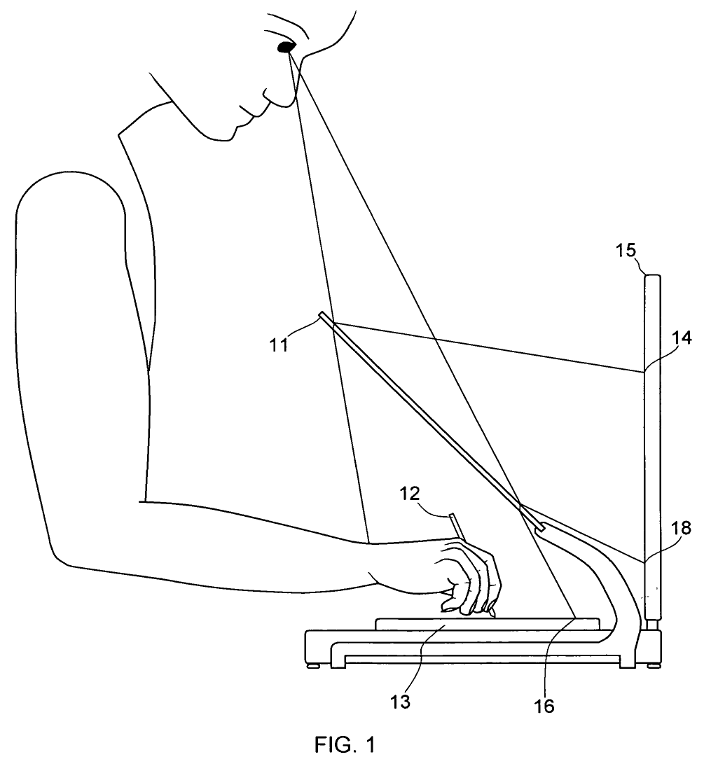

The embodiment illustrated in FIG. 1 shows a user observing a tablet 13 through a transparent plate 11. A partial reflection of an image source 15 in plate 11 creates a virtual image that appears to the user to be in the same plane as the top of tablet 13. As the user signs tablet 13 with a stylus 12, the tablet detects the location of the stylus tip. The mirror image of the signature is displayed on image source 15, preferably as a bright line in a dark background. The stylus 12 thus appears to be leaving a signature across the top surface of tablet 13.

A far display point 18 on image source 15 appears to be at far sensing point 16 on the tablet 13. A near display point 14 appears to the user to exist along the near edge of tablet 13, even though this portion of the tablet is blocked by the user's own wrist: the existence of the user's hand above the tablet 13 does not impede the user's view of the virtual image caused by the partial reflection of image source 15 in plate 11. This enables the perception that the user can see through the hand. Such a perception may be useful as a tool when teaching left-handed children to write, since they will be capable of seeing what they have just written, even though their left hand covers the words as they are being written.

Image source 15 could be articulated. For example, if image source 15 rotates relative to plate 11 about an axis passing through the plane of plate 11 and tablet 13 is rotated about the same axis by the same amount but in the opposite direction, plate 11 would still bisect the plane of tablet 13 and the plane of image source 15. With this type of fully synchronous articulation, the virtual image would remain both in the plane of the top surface of tablet 13 and aligned with tablet 13.

If the image source were rotated relative to plate 11 about an axis not passing through plate 11, and plate 11 were rotated to bisect the plane of tablet 13 and the plane of image source 15, the virtual image would remain in the plane of the top surface of tablet 13 but would appear to move relative to tablet 13 unless compensated for. With this type of locational adjustment, the image source 15 would have to be remapped to maintain correspondence of the virtual image displayed at the surface of tablet 13 to the input sensed by tablet 13.

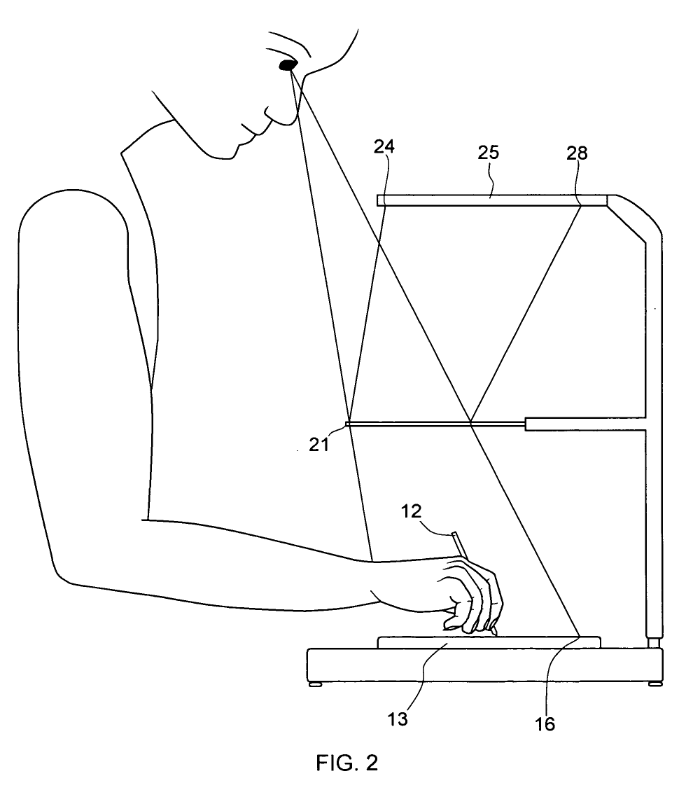

FIG. 2 illustrates an embodiment where an image source 25 is reflected by a transparent plate 21 to create a virtual image at the top of tablet 13. A far display point 28 on image source 25 appears to exist on the top surface of tablet 13 at far sensing point 16. A near display point 24 appears to the user to exist along the near edge of tablet 13, even though this portion of the tablet is blocked by the user's own wrist. As the user signs tablet 13 with stylus 12, the tablet detects the location of the stylus tip. The mirror image of the signature is displayed on image source 25, preferably as a bright line in a dark background. The stylus 12 thus appears to be leaving a signature across the top surface of tablet 13.

Because image source 25 faces downwards, displayed information is not readily visible to anyone but the user. This facilitates the secure exchange or verification of private information in a public setting. If desired, image source 25 could be articulated, e.g. allowed move vertically with respect to tablet 13. In such an embodiment, plate 21 would move vertically with respect to tablet 13 by half as much as image source 25, so that the plane of plate 21 would continue to bisect the planes defined by image source 25 and tablet 13. The virtual image would thus remain in the plane of the top surface of tablet 13 and aligned with tablet 13.

To reduce the impact of secondary reflections, the partially reflective plate should be more reflective on the side towards image source than on the side towards tablet 13. For embodiments such as FIG. 1 where the angle between the user's line of sight and the partially reflective plate is small, this may be done by placing an anti-reflective coating on the side towards the tablet 13; a 0.02-0.04 mm layer of low density polyethylene was effective for this purpose. Alternatively, for embodiments such as FIG. 2 where the angle between the user's line of sight and the partially reflective plate is larger, the side of the plate towards image source may be partially mirrored, preferably resulting in 15-60% reflectivity.

Separating the two functions of sensing the stylus location and displaying the track that the stylus has made allows each of these functions to be performed more precisely, because neither has to be compromised to accommodate the other. Displaying the signature in the same plane as the stylus tip provides an interface that better simulates a traditional signature on paper. Avoiding parallax error also facilitates synchronization of the sensing and display functions. For example, the alignment and congruence of the sensing and display functions can be calibrated by displaying at least two and preferably four reference points on the tablet and having an operator press the stylus tip to each reference point. This would allow the system to accurately correlate the location of the stylus tip sensed by the tablet to the display of that input by the image source.

A control system receiving input signals from the tablet and sending output signals to the image source can not only allow the virtual image at the input surface to display written input, but can also indicate a change in functionality of portions of the input surface initiated by the user, e.g., by displaying a drop-down menu in response to a user input. The system may also display a change in the function of an icon, button, or key depicted within the virtual image in response to a control signal.

What is claimed is:

1. An apparatus comprising:
an electronically readable input device having an input surface at a first location;
an electronically controllable image source at a second location different from the first location; and
a partially reflective plate, through which the input surface can be observed,
whereby partial reflection of the image source in the partially reflective plate creates a virtual image of the image source that appears to exist at the input surface.

2. The apparatus of claim 1, further comprising a controller adapted to:
receive a first signal from the input device, indicative of a user input at an input point; and
send a second signal to the image source in response to the first signal,
whereby the virtual image created by partial reflection of the image source in the partially reflective plate appears to react to the user input at the input point.

3. The apparatus of claim 2,
wherein the user input comprises writing with a stylus on the input surface; and
wherein the virtual image created by partial reflection of the image source in the partially reflective plate indicates the stylus tip location.

4. The apparatus of claim 1, wherein the user input comprises writing with a stylus on the input surface, further comprising a controller adapted to:
receive a first signal from the input device, indicative of the stylus location; and
send a second signal to the image source corresponding to a path followed by the stylus tip location,
whereby the virtual image created by partial reflection of the image source in the partially reflective plate displays the path of the stylus tip location.

5. The apparatus of claim 1, further comprising a controller adapted to:
receive a first signal from the input device, indicative of a user input at an input point; and
send a second signal to the image source in response to the first signal,
whereby the virtual image created by partial reflection of the image source in the partially reflective plate indicates a change in functionality of at least a portion of the input surface other than the input point.

6. The apparatus of claim 1,
wherein the electronically controllable image source faces downwards,
whereby view of the electronically controllable image source is restricted.

7. The apparatus of claim 1,
wherein alignment of the virtual image to the input surface does not depend upon sensing a user's perspective.

8. The apparatus of claim 1,
further comprising synchronous articulation of the image source and the partially reflective plate,
whereby the image source may be moved relative to the input surface while the virtual image remains in the plane of the input surface.

9. A method comprising:
sensing a manual input at an input point of an input surface at a first location;
modifying a visual attribute of an image source at a second location different from the first location in response to the manual input; and
reflecting the image source in a partially reflective plate through which the input surface can be observed,
thereby creating a virtual image of the image source at the input surface,
whereby the input surface appears to react to the manual input.

10. The method of claim 9,
wherein the virtual image appears to react to the manual input at the input point.

11. The method of claim 10,
wherein the manual input comprises writing with a stylus, and
wherein the virtual image displays the path of the stylus in the plane of the input surface.

12. The method of claim 9,
wherein the virtual image indicates a change in functionality of at least a portion of the input surface.

13. The method of claim 9,
wherein the virtual image indicates a change in functionality of at least a portion of the input surface other than the input point.

14. The method of claim 9,
wherein the image on the electronically controllable image source faces downwards,
whereby view of the electronically controllable image source is restricted.

15. The method of claim 9,
wherein alignment of the virtual image to the input surface does not depend upon sensing a user's perspective.

16. A computer program product, tangibly embodied in a machine-readable medium, the computer program product comprising instructions that, when read by a machine, operate to cause data processing apparatus to performs the steps of:
receiving a signal indicative of a manual input at an input point of an input surface at a first location; and
displaying a mirror image of the input on an electronically controllable display at a second location different from the first location,
whereby a reflection of the display creates a virtual image in the first location indicative of the manual input.

17. The computer program product of claim 16,
wherein the manual input comprises writing with a stylus, and
wherein the virtual image displays the stylus path at the input surface.

18. The computer program product of claim 17,
wherein the stylus path is depicted as a bright image in a dark background.

19. The computer program product of claim 16, wherein the computer program product further comprises instructions that, when read by a machine, operate to cause data processing apparatus to performs the steps of:
receiving a signal indicative of a control input from the input surface; and
modifying the image on the electronically controllable display,
whereby a reflection of the display creates a virtual image in the first location indicative of a change in how subsequent manual input will be interpreted.

20. The computer program product of claim 16, further comprising the steps of:
receiving a signal indicative of a locational adjustment of the image source relative to the input surface; and
modifying the image on the electronically controllable display to maintain alignment of the virtual image with the manual input.
